(19) United States
(12) Patent Application Publication
(10) Pub. No.: US 2025/0125419 A1
(43) Pub. Date: Apr. 17, 2025

(54) BATTERY

(71) Applicant: ZHUHAI COSMX BATTERY CO., LTD., Zhuhai (CN)

(72) Inventors: Hai WANG, Zhuhai (CN); Suli LI, Zhuhai (CN)

(73) Assignee: ZHUHAI COSMX BATTERY CO., LTD., Zhuhai (CN)

(21) Appl. No.: 19/002,684

(22) Filed: Dec. 26, 2024

Related U.S. Application Data
(63) Continuation-in-part of application No. PCT/CN2023/125748, filed on Oct. 20, 2023.

(30) Foreign Application Priority Data
Dec. 28, 2022 (CN) 202211701043.3

(51) Int. Cl. H01M 10/0567; H01M 4/38; H01M 4/587; H01M 4/62; H01M 10/0525

(52) U.S. Cl. CPC H01M 10/0567; H01M 4/386; H01M 4/587; H01M 4/625; H01M 10/0525; H01M 2300/0025

(57) ABSTRACT

A battery includes a positive electrode plate, a negative electrode plate, a separator, and an electrolyte solution which includes a lithium salt, an organic solvent, a first additive, and a second additive. The first additive is selected from a cyclic silane compound containing an unsaturated bond, and the second additive is selected from at least one of fluorinated cyclic carbonate compounds. The battery satisfies 115≤(a+1/5b)/(t×p)≤700, where a is a mass percentage of the first additive in a total mass of the electrolyte solution in wt %, b is a mass percentage of the second additive in the total mass of the electrolyte solution in wt %, t is a mass of a single-side negative electrode active material layer per unit area in g/cm², and p is a specific surface area of the negative electrode active material in m²/g.

### CROSS-REFERENCE TO RELATED APPLICATIONS

The present disclosure is a continuation-in-part application of International Application No. PCT/CN2023/125748, filed on Oct. 20, 2023, which claims priority to Chinese Patent Application No. CN202211701043.3, filed on Dec. 28, 2022. The disclosures of the aforementioned applications are hereby incorporated by reference in their entireties.

### TECHNICAL FIELD

The present disclosure pertains to the field of battery technologies, and specifically, relates to a battery, and in particular, to a battery with good high-temperature cycling performance, good high-temperature storage performance, and high safety performance.

### BACKGROUND

Lithium-ion batteries are widely used in various types of electronic products due to their advantages such as high specific energy density and long cycle life. In recent years, lithium-ion batteries have also been widely used in electric vehicles, various power tools, and energy storage apparatuses. As the application scope of lithium-ion batteries expands, sizes of batteries are also becoming increasingly large, and safety performance of batteries becomes particularly important. Moreover, with the improvement of people's living standards and their desire for a better life, higher requirements are placed on battery energy density.

In order to improve energy density of a battery, increasing a voltage of a positive electrode material of a lithium-ion battery is a common approach. However, as a limiting voltage of the positive electrode material increases continuously, a specific capacity of the positive electrode material gradually increases, high-temperature performance of the battery deteriorates severely, and long cycle life cannot be ensured. Especially at a high voltage, during long-term cycle charge and discharge, a volume of the positive electrode material expands and causes severely cracks, the electrolyte solution enters the interior of the positive electrode material, destroying a structure of the positive electrode material, and release of active oxygen further accelerates oxidative decomposition of the electrolyte solution. In addition, an ultra-high specific capacity of a silicon negative electrode material can also improve energy density of the battery. However, particles on surface of the silicon negative electrode material are prone to breakage and have a large volume expansion rate, which is likely to lead to a relatively large quantity of side reactions of the electrolyte solution on the surface, ultimately causing a problem of severe capacity attenuation of the battery.

Therefore, it is very important to invent a battery with better safety and higher cycle stability.

### SUMMARY

Currently, a surface of a positive electrode material is usually modified with an oxide coating, or positive electrode materials with different shapes and structures are prepared, but with a complex process, high costs, and a poor protection effect.

In order to solve a problem that stress generated by volume expansion of the positive electrode material and volume expansion of a negative electrode material in a battery at a high voltage damages a surface of an electrode material, causing a solid electrolyte film on an electrode surface to crack, and producing active oxygen oxidizing an electrolyte solution, the present disclosure provides a battery. The battery includes a positive electrode plate, a negative electrode plate, a separator, and an electrolyte solution, and additives of the electrolyte solution include a cyclic silane compound containing an unsaturated bond and a fluorinated cyclic carbonate compound. Through a synergistic effect between a mass of the single-side negative electrode active material layer per unit area in the negative electrode plate, a specific surface area of the negative electrode active material, and the additives of the electrolyte solution, high-temperature cycling performance and high-temperature storage performance of the prepared battery can be effectively improved, and safety performance of the battery against thermal shock can be further improved.

Objectives of the present disclosure are achieved by using the following technical solutions.

A battery is provided. The battery includes a positive electrode plate, a negative electrode plate, a separator, and an electrolyte solution, the electrolyte solution includes a lithium salt, an organic solvent, a first additive, and a second additive, the first additive is selected from a cyclic silane compound containing an unsaturated bond, and the second additive is selected from at least one of fluorinated cyclic carbonate compounds.

The negative electrode plate includes a negative electrode current collector and a negative electrode active material layer coated on a surface of either or both sides of the negative electrode current collector, and the negative electrode active material layer includes a negative electrode active material, a negative conductive agent, and a negative binder.

The battery satisfies the following relational expression:

$$115 \leq ( a + 1 / 5 \times b ) / ( t \times p ) \leq 700$$

where a is a mass percentage of the first additive in a total mass of the electrolyte solution in wt %, b is a mass percentage of the second additive in the total mass of the electrolyte solution in wt %, t is a mass of a single-side negative electrode active material layer per unit area in g/cm², and p is a specific surface area of the negative electrode active material in m²/g.

Beneficial effects of the present disclosure are as follows.

The present disclosure provides a battery. It is found, through correlation between a specific surface area of the negative electrode active material per unit area and content of the additives, that there is a synergistic effect between them. To be specific, volume expansion of the negative electrode material can be effectively suppressed by adjusting the mass of the single-side negative electrode active material layer per unit area in the negative electrode plate, the specific surface area of the negative electrode active material, and the additives of the electrolyte solution, to avoid a problem that stress generated by volume expansion of the negative electrode material in damages a surface of an electrode material, causing a solid electrolyte film on an electrode surface to crack, and oxidizing an electrolyte solution. In addition, high-temperature cycling performance and high-temperature storage performance of the prepared battery can be significantly improved, and safety performance of the battery against thermal shock can be further improved.

Specifically, the cyclic silane compound containing an unsaturated bond in the electrolyte solution has higher stability than a chain silane compound containing an unsaturated bond due to its cyclic structural characteristic. At a high voltage, a silicon-carbon bond formed by a cyclic silicon atom and a branched molecule is broken due to oxidative decomposition, and a broken silicon-oxygen bond is further oxidized. Some of oxidation products and the organic solvent (such as EC) in the electrolyte solution undergo polymerization reaction to form a polymer that can form a protective film not only on surface of the positive electrode, but also on a surface of the negative electrode. The cyclic silane compound containing an unsaturated bond can further generate a compound containing an —Si—X—F— bond after continuous oxidation, and the compound containing the —Si—X—F— bond can participate in film formation on surfaces of positive and negative electrodes.

Under conventional high-temperature and fully charged conditions, the solid electrolyte film on the electrode surface has poor thermal stability and is prone to deformation, loosening, and pore enlargement, leading to further reduction of the solvent at the negative electrode. Unsaturated double bonds on side chains of cyclic silane compounds containing unsaturated bonds in the present disclosure can undergo polymerization reaction on the surface of the negative electrode to form a mesh protective film containing Si—X—F, and the formed mesh protective film containing Si—X—F has a specific toughness, which can enhance robustness and structural stability of a SEI film and suppress deformation of the SEI film. This effectively suppresses volume expansion of the negative electrode material. On this basis, further adjusting the mass of the single-side negative electrode active material layer per unit area in the negative electrode plate and the specific surface area of the negative electrode active material to enable the specific surface area of the negative electrode material per unit area to match the content of the additives can significantly improve high-temperature storage performance and high-temperature cycling performance of the battery. Moreover, the introduced second additive and the first additive can work together on the surface of the negative electrode to form a dense and repairable polymeric network layer on the surface of the negative electrode without increasing impedance, further suppressing volume expansion of the negative electrode material. The two additives work synergistically to protect the positive and negative electrodes and prevent further decomposition of the electrolyte solution.

### DETAILED DESCRIPTION OF THE EMBODIMENTS

The preparation method in the present disclosure is further described in detail below with reference to specific embodiments. It should be understood that the following embodiments are merely intended to illustrate and explain the present disclosure as examples, and shall not be construed as limiting the protection scope of the present disclosure. Any technology implemented based on the foregoing content of the present disclosure falls within the intended protection scope of the present disclosure.

The present disclosure provides a battery. The battery includes a positive electrode plate, a negative electrode plate, a separator, and an electrolyte solution, the electrolyte solution includes a lithium salt, an organic solvent, a first additive, and a second additive, the first additive is selected from a cyclic silane compound containing an unsaturated bond, and the second additive is selected from at least one of fluorinated cyclic carbonate compounds.

The negative electrode plate includes a negative electrode current collector and a negative electrode active material layer coated on a surface of either or both sides of the negative electrode current collector, and the negative electrode active material layer includes a negative electrode active material, a negative conductive agent, and a negative binder.

The battery satisfies the following relational expression:

$$115 \leq ( a + 1 / 5 \times b ) / ( t \times p ) \leq 700$$

where a is a mass percentage of the first additive in a total mass of the electrolyte solution in wt %, b is a mass percentage of the second additive in the total mass of the electrolyte solution in wt %, t is a mass of a single-side negative electrode active material layer per unit area in g/cm², and p is a specific surface area of the negative electrode active material in m²/g.

When the battery satisfies 115≤(a+1/5×b)/(t×p)≤700, additives per unit mass can effectively protect a negative electrode active material per unit specific surface area to form a suitable protective layer on a surface of the negative electrode active material, so as to fully suppress volume expansion of the negative electrode active material and significantly improve high-temperature cycling performance, high-temperature storage performance, and safety performance of the battery. When the battery does not satisfy 115≤(a+1/5×b)/(t×p)≤700, additives per unit mass are insufficient to provide adequate protection for the negative electrode active material per unit specific surface area or a formed protective layer is too thick. Consequently, high-temperature cycling performance, high-temperature storage performance, and safety performance of the battery are not improved significantly.

In one example, 130≤(a+1/5×b)/(t×p)≤200.

In one example, (a+1/5×b)/t×p) is 115, 120, 130, 140, 150, 160, 170, 180, 200, 220, 250, 280, 300, 320, 350, 380, 400, 420, 450, 480, 500, 520, 550, 580, 600, 620, 650, 680, or 700.

In one example, 0.05 wt %≤a wt %≤5 wt %, that is, the mass percentage a of the mass of the first additive in the total mass of the electrolyte solution is 0.05 wt %, 0.1 wt %, 0.2 wt %, 0.3 wt %, 0.4 wt %, 0.5 wt %, 0.6 wt %, 0.8 wt %, 0.9 wt %, 1 wt %, 1.2 wt %, 1.5 wt %, 1.8 wt %, 2 wt %, 2.2 wt %, 2.5 wt %, 2.8 wt %, 3.0 wt %, 3.4 wt %, 3.5 wt %, 4 wt %, 4.5 wt %, 4.8 wt %, or 5 wt %.

In one example, 3.5 wt %≤b wt %≤15 wt %, that is, the mass percentage b of the second additive in the total mass of the electrolyte solution is 3.5 wt %, 4 wt %, 4.5 wt %, 5 wt %, 6 wt %, 7 wt %, 8 wt %, 9 wt %, 10 wt %, 11 wt %, 12 wt %, 13 wt %, 14 wt %, or 15 wt %.

In one example, 0.0045 g/cm²≤t g/cm²≤0.028 g/cm², that is, the mass t of the single-side negative electrode active material layer per unit area is 0.005 g/cm², 0.006 g/cm², 0.008 g/cm², 0.009 g/cm², 0.01 g/cm², 0.11 g/cm², 0.012 g/cm², 0.013 g/cm², 0.014 g/cm², 0.15 g/cm², 0.017 g/cm², 0.018 g/cm², or 0.02 g/cm².

In one example, 0.55 m²/g≤p m²/g≤2.35 m²/g, where the specific surface area p of the negative electrode active material is 0.6 m²/g, 0.7 m²/g, 0.8 m²/g, 0.9 m²/g, 1.0 m²/g, 1.1 m²/g, 1.2 m²/g, 1.3 m²/g, 1.4 m²/g, 1.5 m²/g, 1.6 m²/g, 1.7 m²/g, 1.8 m²/g, 1.9 m²/g, or 2 m²/g.

In one example, the cyclic silane compound containing an unsaturated bond is a six-membered cyclic silane compound containing a carbon-carbon double bond.

In one embodiment, the cyclic silane compound containing an unsaturated bond has a structural formula shown in Formula I:

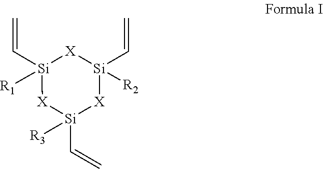

where in Formula I, R₁, R₂, and R₃ are the same or different and are independently selected from hydrogen, halogen, substituted or unsubstituted alkyl, substituted or unsubstituted alkenyl, substituted or unsubstituted cycloalkyl, or substituted or unsubstituted aryl; and when “substituted” is used, a substituent is halogen or alkyl; and X is selected from —CH₂—, —O—, —S—, NH, PH, or BH.

In one example, R₁, R₂, and R₃ are the same or different and are independently selected from hydrogen, halogen, substituted or unsubstituted C₁₋₂₀ alkyl, substituted or unsubstituted C₂₋₂₀ alkenyl, substituted or unsubstituted 3-20 membered cycloalkyl, or substituted or unsubstituted C₆₋₂₀ aryl; and when “substituted” is used, the substituent is halogen or C₁₋₂₀ alkyl.

In one example, R₁, R₂, and R₃ are the same or different and are independently selected from hydrogen, halogen, substituted or unsubstituted C₁₋₁₂ alkyl, substituted or unsubstituted C₂₋₁₂ alkenyl, substituted or unsubstituted 3-12 membered cycloalkyl, or substituted or unsubstituted C₆₋₁₂ aryl; and when “substituted” is used, the substituent is halogen or C₁₋₁₂ alkyl.

In one example, R₁, R₂, and R₃ are the same or different and are independently selected from hydrogen, halogen, substituted or unsubstituted C₁₋₆ alkyl, substituted or unsubstituted C₂₋₆ alkenyl, substituted or unsubstituted 3-6 membered cycloalkyl, or substituted or unsubstituted C₆₋₁₀ aryl; and when “substituted” is used, the substituent is halogen or C₁₋₆ alkyl.

In one example, R₁, R₂, and R₃ are the same or different and are independently selected from hydrogen, halogen, substituted or unsubstituted C₁₋₃ alkyl, substituted or unsubstituted C₂₋₃ alkenyl, substituted or unsubstituted 3-6 membered cycloalkyl, or substituted or unsubstituted C₆₋₈ aryl; and when “substituted” is used, the substituent is halogen or C₁₋₃ alkyl.

In one example, the first additive may be prepared by using a method known in the art, or may be purchased commercially.

In one example, the first additive is selected from at least one of the following compounds shown in Formula I-1 to Formula I-15:

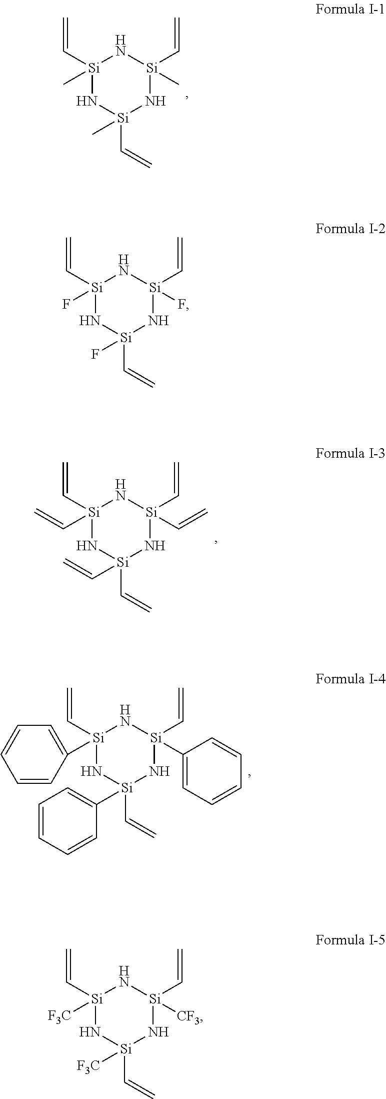 [SMILES: C=C[Si]1(C)N[Si](C)(C=C)N[Si](C)(C=C)N1 ; C=C[Si]1(F)N[Si](F)(C=C)N[Si](F)(C=C)N1 ; C=C[Si]1(C=C)N[Si](C=C)(C=C)N[Si](C=C)(C=C)N1 ; C=C[Si]1(c2ccccc2)N[Si](C=C)(c2ccccc2)N[Si](C=C)(c2ccccc2)N1 ; C=C[Si]1(C(F)(F)F)N[Si](C=C)(C(F)(F)F)N[Si](C=C)(C(F)(F)F)N1]

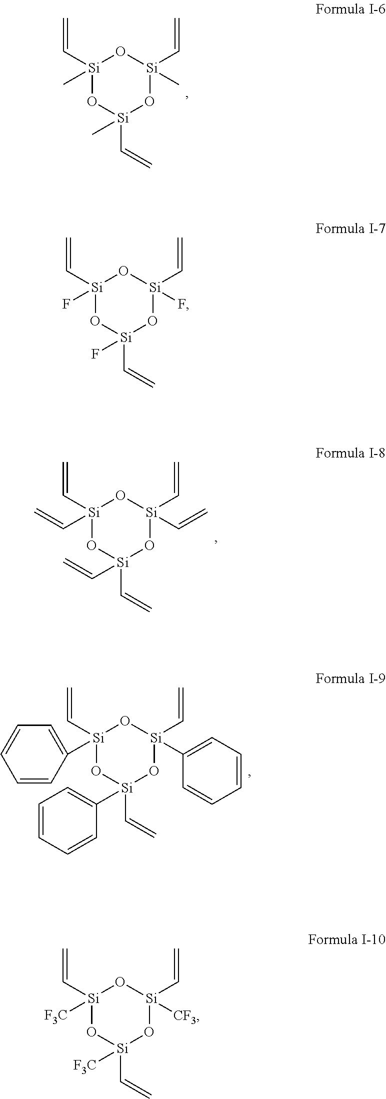 [SMILES: C=C[Si]1(C)O[Si](C)(C=C)O[Si](C)(C=C)O1 ; C=C[Si]1(F)O[Si](F)(C=C)O[Si](F)(C=C)O1 ; C=C[Si]1(C=C)O[Si](C=C)(C=C)O[Si](C=C)(C=C)O1 ; C=C[Si]1(c2ccccc2)O[Si](C=C)(c2ccccc2)O[Si](C=C)(c2ccccc2)O1 ; C=C[Si]1(C(F)(F)F)O[Si](C=C)(C(F)(F)F)O[Si](C=C)(C(F)(F)F)O1]

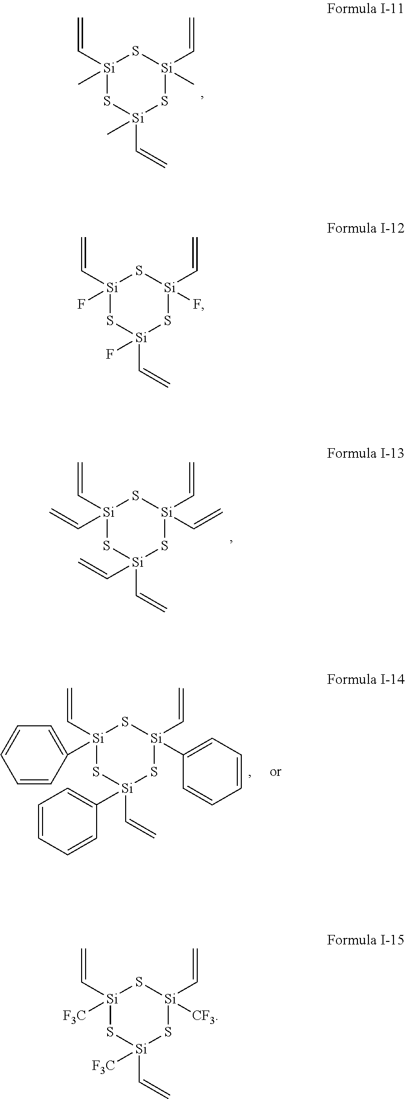 [SMILES: C=C[Si]1(C)S[Si](C)(C=C)S[Si](C)(C=C)S1 ; C=C[Si]1(F)S[Si](F)(C=C)S[Si](F)(C=C)S1 ; C=C[Si]1(C=C)S[Si](C=C)(C=C)S[Si](C=C)(C=C)S1 ; C=C[Si]1(c2ccccc2)S[Si](C=C)(c2ccccc2)S[Si](C=C)(c2ccccc2)S1 ; C=C[Si]1(C(F)(F)F)S[Si](C=C)(C(F)(F)F)S[Si](C=C)(C(F)(F)F)S1]

In one example, the fluorinated cyclic carbonate compound has at least one of the structural formulas shown in Formula II:

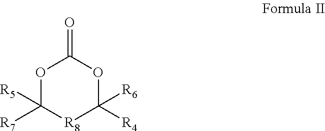

where in Formula II, R₄, R₅, R₆, and R₇ are the same or different and are independently selected from hydrogen, fluorine, alkyl, or fluorine-substituted alkyl, and at least one group of R₄, R₅, R₆, or R₇ is selected from fluorine or fluorine-substituted alkyl; and R₈ is absent, —CH2- or fluorine substitution.

In one example, R₄, R₅, R₆, and Rare the same or different and are independently selected from hydrogen, fluorine, C₁₋₁₂ alkyl, or fluorine-substituted C₁₋₁₂ alkyl, and at least one group of R₄, R₅, R₆, or R₇ is selected from fluorine or fluorine-substituted C₁₋₁₂ alkyl.

In one example, R₄, R₅, R₆, and R₇ are the same or different and are independently selected from hydrogen, fluorine, C₁₋₆ alkyl, or fluorine-substituted C₁₋₆ alkyl, and at least one group of R₄, R₅, R₆, or R₇ is selected from fluorine or fluorine-substituted C₁₋₆ alkyl.

In one example, R₄, R₅, R₆, and R₇ are the same or different and are independently selected from hydrogen, fluorine, C₁₋₃ alkyl, or fluorine-substituted C₁₋₃ alkyl, and at least one group of R₄, R₅, R₆, or R₇ is selected from fluorine or fluorine-substituted C₁₋₃ alkyl.

In one example, the second additive is selected from at least one of the following compounds shown in Formula II-1 to Formula II-9:

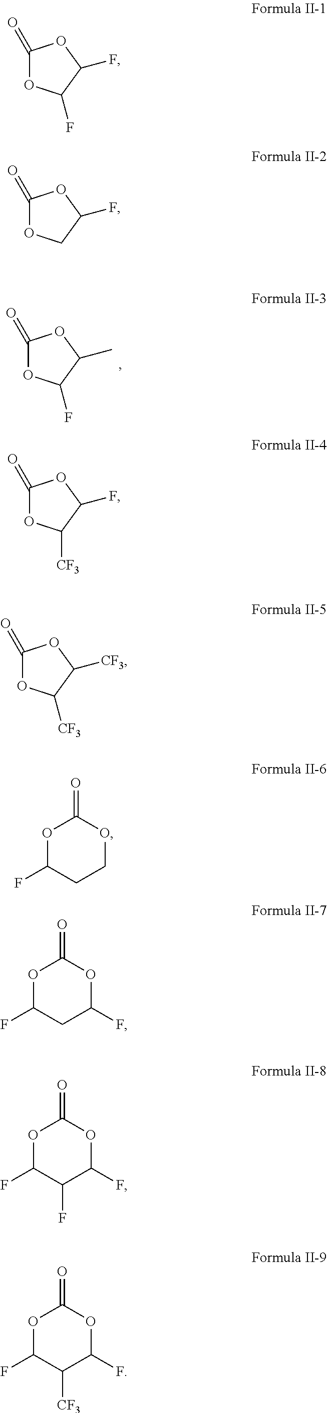

In one example, the lithium salt is selected from one or more of lithium hexafluorophosphate (LiPF₆), lithium difluorophosphate (LiPO₂F₂), lithium difluoro (oxalato) borate (LiDFOB), lithium bis((trifluoromethanesulfonyl)imide, lithium difluorobis(oxalato)phosphate, lithium tetrafluoroborate, lithium bis(oxalate) borate, lithium hexafluoroantimonate, lithium hexafluoroarsenate, lithium bis(pentafluoroethylsulfonyl)imine, tri (trifluoromethyl sulfonyl)methyllithium, or lithium bis(trifluoromethyl sulfonyl)imine.

In one example, a mass of the lithium salt accounts for 10 wt % to 15 wt % of a total mass of the electrolyte solution, for example, 10 wt %, 11 wt %, 12 wt %, 13 wt %, 14 wt %, or 15 wt %.

In one example, the organic solvent is selected from carbonate and/or carboxylate, and the carbonate is selected from one or more of the following fluorinated or unsubstituted solvents: ethylene carbonate (EC), propylene carbonate (PC), dimethyl carbonate, diethyl carbonate (DEC), or ethyl methyl carbonate; and the carboxylate is selected from one or more of the following fluorinated or unsubstituted solvents: propyl acetate, n-butyl acetate, isobutyl acetate, n-amyl acetate, isoamyl acetate, propyl propionate (PP), ethyl propionate (EP), methyl butyrate, or ethyl n-butyrate.

In one example, a mass of the organic solvent accounts for 65 wt % to 80 wt % of a total mass of the electrolyte solution.

In one example, the lithium salt further includes a third additive.

In one example, the third additive includes one or more of 1,3-propane sultone, 1,3,6-hexanetricarbonitrile (HTCN) or adiponitrile (ADN).

In one example, the positive electrode plate includes a positive electrode current collector and a positive electrode active material layer coated on a surface of either or both sides of the positive electrode current collector, and the positive electrode active material layer includes a positive electrode active material, a positive conductive agent, and a positive binder.

In one example, mass percentages of components in the positive electrode active material layer are as follows: 80 wt % to 99.8 wt % (for example, 80 wt %, 85 wt %, 90 wt %, 95 wt %, or 99.8 wt %) for the positive electrode active material, 0.1 wt % to 10 wt % (for example, 0.1 wt %, 0.5 wt %, 1 wt %, 3 wt %, 5 wt %, 7 wt %, or 10 wt %) for the positive conductive agent, and 0.1 wt % to 10 wt % (for example, 0.1 wt %, 0.5 wt %, 1 wt %, 3 wt %, 5 wt %, 7 wt %, or 10 wt %) for the positive binder.

In one example, the mass percentages of the components in the positive electrode active material layer are as follows: 90 wt % to 99.6 wt % for the positive electrode active material, 0.2 wt % to 5 wt % for the positive conductive agent, and 0.2 wt % to 5 wt % for the positive binder.

In one example, mass percentages of components in the negative electrode active material layer are as follows: 80 wt % to 99.8 wt % (for example, 80 wt %, 85 wt %, 90 wt %, 95 wt %, or 99.8 wt %) for the negative electrode active material, 0.1 wt % to 10 wt % (for example, 0.1 wt %, 0.5 wt %, 1 wt %, 3 wt %, 5 wt %, 7 wt %, or 10 wt %) for the negative conductive agent, and 0.1 wt % to 10 wt % (for example, 0.1 wt %, 0.5 wt %, 1 wt %, 3 wt %, 5 wt %, 7 wt %, or 10 wt %) for the negative binder.

In one example, the mass percentages of the components in the negative electrode active material layer are as follows: 90 wt % to 99.6 wt % for the negative electrode active material, 0.2 wt % to 5 wt % for the negative conductive agent, and 0.2 wt % to 5 wt % for the negative binder.

In one example, the negative conductive agent and the positive conductive agent are independently selected from at least one of conductive carbon black (SP), acetylene black, Ketjen black, conductive graphite, conductive carbon fiber, carbon nanotubes (such as single-walled carbon nanotubes (SWCNTs)), metal powder, or carbon fiber.

In one example, the negative binder and the positive binder are independently selected from at least one of sodium carboxymethyl cellulose, styrene-butadiene latex, polytetrafluoroethylene, polyethylene oxide, or polyvinylidene fluoride (PVDF).

In one example, the negative electrode active material is at least one of a silicon-based negative electrode material or a carbon-based negative electrode material.

In one example, the carbon-based negative electrode material is selected from at least one of artificial graphite, natural graphite, mesocarbon microbeads, hard carbon, or soft carbon.

In one example, the silicon-based negative electrode material is selected from at least one of a silicon-carbon negative electrode material or a silicon-oxygen negative electrode material.

In one example, the negative electrode active material is a silicon-carbon and graphite material, or a silicon-oxygen and graphite material.

In one example, the positive electrode active material is selected from one or more of lithium transition metal oxide, lithium iron phosphate, lithium manganate. The lithium transition metal oxide has a chemical formula of Li₁₊ₓNi_{y}CO_{z}M_{(1-y-z)}O₂, where −0.1≤x≤1, 0≤y≤1, 0≤z≤1, and 0≤y+z≤1. Mis one or more of Mg, Zn, Ga, Ba, Al, Fe, Cr, Sn, V, Mn, Sc, Ti, Nb, Mo, or Zr.

Experimental methods used in the following examples are conventional methods, unless otherwise specified. Reagents, materials, and the like used in the following examples are all commercially available, unless otherwise specified.

A lithium-ion battery was prepared through the following steps.

### (1) Preparation of a Positive Electrode Plate

Positive electrode active materials lithium cobaltate (LiCoO₂), polyvinylidene fluoride (PVDF), SP (super P), and carbon nanotubes (CNT) were mixed at a mass ratio of 96:2:1.5:0.5, and were added with N-methylpyrrolidone (NMP). The mixture was stirred under action of a vacuum blender until the mixture became a uniform fluid positive electrode active slurry. Both surfaces of an aluminum foil were coated evenly with the positive electrode active slurry. The coated aluminum foil was dried, then rolled, and cut, to obtain a required positive electrode plate.

### (2) Preparation of a Negative Electrode Plate

Negative electrode active materials silicon-carbon composite and artificial graphite (containing 5% for silicon-carbon composite and 95% for artificial graphite), sodium carboxymethyl cellulose (CMC-Na), styrene-butadiene rubber, conductive carbon black (SP), and single-walled carbon nanotubes (SWCNTs) were mixed at a mass ratio of 94.5:2.5:1.5:1:0.5, and were added with deionized water. The mixture was stirred under action of a vacuum blender to obtain a negative electrode active slurry. Both sides of a copper foil were coated with evenly with the negative electrode active slurry. The coated copper foil was dried at room temperature, was then transferred to an oven for drying at 80° C. for 10 hours, and was cold-pressed and cut, to obtain a negative electrode plate. A mass of a single-side negative electrode active material layer per unit area was t, expressed in g/cm², and a specific surface area of the negative electrode active material was p, expressed in m²/g.

### (3) Preparation of an Electrolyte Solution

In an argon-filled glovebox (H₂O<0.1 ppm, O₂<0.1 ppm), EC, PC, DEC, and PP (where EC is ethylene carbonate, PC is propylene carbonate, DEC is diethyl carbonate, and PP is propyl propionate) were uniformly mixed at a mass ratio of 10:10:20:60, then were added with fully dried lithium hexafluorophosphate (LiPF₆) with 13 wt % of a total mass of the electrolyte solution, and after dissolution, were added with 1,3-propane sultone with 3 wt %, 1,3,6-hexanetricarbonitrile (HTCN) with 3 wt %, and adiponitrile (ADN) with 3 wt % of the total mass of the electrolyte solution, the first additive, and the second additive. The electrolyte solution was prepared after being mixed uniformly.

### (4) Preparation of a Lithium-Ion Battery

The positive electrode plate in step (1), the negative electrode plate in step (2), and a separator were stacked in an order of the positive electrode plate, the separator, and the negative electrode plate, and then were rolled up to obtain a battery cell. The battery cell was placed in an outer packaging aluminum foil, and the electrolyte solution in step (3) was injected into the outer packaging, and the lithium-ion battery was obtained through processes of vacuum packaging, standing, formation, shaping, sorting, and the like. A charge and discharge range of the battery in the present disclosure ranges from 3 V to 4.5 V.

### Examples 1 to 14 and Comparative Examples 1 to 5

Examples 1 to 14 are the same as Comparative Examples 1 to 5, except that selection and content of the first additive and the second additive vary, and a mass t of a single-side negative electrode active material layer per unit area and a specific surface area p of a negative electrode active material vary, specifically as shown in Table 1.

Example 1 is used as an example, and (a+1/5×b)/(t×p)=(0.2+1/5×5)/(0.015×0.6)=133.3.

TABLE 1
Composition of batteries in the
Examples and Comparative Examples

| | a % | b % | t g/cm² | p m²/g | (a + 1/5 × b)/(t × p) |
|---|---|---|---|---|---|
| Example 1 | I-1/0.2 | II-1/5 | 0.015 | 0.6 | 133.3 |
| Example 2 | I-1/0.5 | II-1/7 | 0.018 | 0.7 | 150.8 |
| Example 3 | I-1/1 | II-1/10 | 0.010 | 1.6 | 187.5 |
| Example 4 | I-1/2 | II-1/12 | 0.013 | 1.8 | 188.0 |
| Example 5 | I-1/0.5 | II-1/15 | 0.020 | 0.9 | 194.4 |
| Example 6 | I-1/2 | II-1/12 | 0.0035 | 1.8 | 698.4 |
| Example 7 | I-1/2 | II-1/12 | 0.013 | 2.5 | 135.4 |
| Example 8 | I-1/2 | II-1/4 | 0.013 | 1.8 | 119.7 |
| Example 9 | I-1/6 | II-1/12 | 0.013 | 1.8 | 359.0 |
| Example 10 | I-2/2 | II-1/12 | 0.013 | 1.8 | 188.0 |
| Example 11 | I-3/2 | II-1/12 | 0.013 | 1.8 | 188.0 |
| Example 12 | I-4/2 | II-1/12 | 0.013 | 1.8 | 188.0 |
| Example 13 | I-1/2 | II-2/12 | 0.013 | 1.8 | 188.0 |
| Example 14 | I-1/2 | II-3/12 | 0.013 | 1.8 | 188.0 |
| Example 15 | I-6/2 | II-1/12 | 0.013 | 1.8 | 188.0 |
| Comparative | I-1/2 | II-1/12 | 0.002 | 1.8 | 1222.2 |
| Example 1 | | | | | |
| Comparative | I-1/2 | II-1/12 | 0.013 | 5.0 | 67.7 |
| Example 2 | | | | | |
| Comparative | I-1/0 | II-1/12 | 0.013 | 1.8 | 102.6 |
| Example 3 | | | | | |
| Comparative | I-1/2 | II-1/2 | 0.013 | 1.8 | 102.6 |
| Example 4 | | | | | |
| Comparative | I-1/2 | II-1/0 | 0.013 | 1.8 | 85.5 |
| Example 5 | | | | | |
| Comparative | I-1/0.05 | II-1/12 | 0.013 | 1.8 | 104.7 |
| Example 6 | | | | | |
| Comparative | I-1/0.5 | II-1/5 | 0.020 | 0.9 | 83.3 |
| Example 7 | | | | | |
| Comparative | I-1/0.2 | II-1/5 | 0.028 | 0.6 | 71.4 |
| Example 8 | | | | | |
| Comparative | I-1/0.2 | II-1/5 | 0.015 | 2.35 | 34.0 |
| Example 9 | | | | | |

The following performance tests were conducted on batteries in the Examples and Comparative Examples.

### (1) 45° C. Cycling Performance Test

The batteries in Table 1 were charged and discharged for 800 cycles within a charge/discharge cut-off voltage range (3.0 V to 4.53 V) at a rate of 1C at 45° C. A discharge capacity of the first cycle was recorded as ×1 mAh, and a discharge capacity of the N^{th} cycle was recorded as y1 mAh. The capacity of the N^{th} cycle was divided by the capacity of the first cycle to obtain cycle capacity retention rate R1=y1/x1 of the N^{th} cycle.

### (2) 85° C. High-Temperature Storage Test

The batteries were first left standing for 10 minutes after undergoing formation and capacity grading, then were discharged at 0.2C to 3 V, were left standing for 10 minutes, then were fully charged at 0.5C with a cut-off rate of 0.05C, and were left standing for 10 minutes. The voltage, internal resistance, and thickness of the fully charged battery were tested at 25±5° C. After the fully charged battery was placed in an 85° C. oven and kept for 8 hours, the hot battery was taken out to test its voltage, internal resistance and thickness, and capacity retention and recovery tests were conducted.

### (3) Safety Performance Test

The battery cells obtained after capacity grading were charged at 0.5° C. to an upper cut-off voltage, and a constant voltage was maintained to 0.05C. At an ambient temperature of 25° C.±5° C., a fully charged sample was placed in a thermal shock test chamber, then the temperature was raised to 140° C.±2° C. at a rate of 15° C.±2° C./min, and this temperature was maintained for 42 minutes before the test ends. Whether the battery catches fire or explodes was observed. If there was no fire or explosion, the safety performance was identified as “safe” and denoted by “Yes”; and if only fire occurs, the safety performance was identified as “fire”, if only explosion occurs, the safety performance was identified as “explosion”, or if both fire and explosion occur, the safety performance was identified as “fire and explosion” and denoted as “No”.

The test results are shown in the following table 2.

TABLE 2
Performance test results of batteries in the Examples and Comparative Examples

| | | | | 85° C. high-temperature | | |
|---|---|---|---|---|---|---|
| | 45° C. high-temperature cycling | | | storage for 8 hours | | 140° C. |
| | capacity retention rate (%) | | | Capacity | Thickness | thermal |
| | 300 | 500 | | retention | expansion | shock |
| | cycles | cycles | 800 cycles | rate (%) | rate (%) | test |
| Example 1 | 96.30 | 88.59 | 79.25 | 93.02 | 1.98 | Yes |
| Example 2 | 96.67 | 85.64 | 80.82 | 89.92 | 5.08 | Yes |
| Example 3 | 96.59 | 85.06 | 78.25 | 89.31 | 5.69 | Yes |
| Example 4 | 97.67 | 88.81 | 83.60 | 93.25 | 1.75 | Yes |
| Example 5 | 96.38 | 87.87 | 78.96 | 92.27 | 2.73 | Yes |
| Example 6 | 85.10 | 75.94 | 68.92 | 69.37 | 10.63 | Yes |
| Example 7 | 82.83 | 75.41 | 68.89 | 68.89 | 11.11 | Yes |
| Example 8 | 84.76 | 76.84 | 69.61 | 70.19 | 9.81 | Yes |
| Example 9 | 83.65 | 77.62 | 71.16 | 70.91 | 9.09 | Yes |
| Example 10 | 92.62 | 82.94 | 74.23 | 82.74 | 12.26 | Yes |
| Example 11 | 91.58 | 85.44 | 74.95 | 85.22 | 9.78 | Yes |
| Example 12 | 91.20 | 84.37 | 75.11 | 84.16 | 10.84 | Yes |
| Example 13 | 92.44 | 84.43 | 77.86 | 84.22 | 10.78 | Yes |
| Example 14 | 91.97 | 84.69 | 76.87 | 84.48 | 10.52 | Yes |
| Example 15 | 91.82 | 83.13 | 74.83 | 84.98 | 10.09 | Yes |
| Comparative | 62.37 | 55.68 | 52.14 | 67.37 | 17.63 | No |
| Example 1 | | | | | | |
| Comparative | 62.44 | 56.36 | 52.09 | 67.44 | 17.56 | No |
| Example 2 | | | | | | |
| Comparative | 63.20 | 56.21 | 52.74 | 68.20 | 16.80 | No |
| Example 3 | | | | | | |
| Comparative | 63.61 | 56.60 | 51.96 | 68.61 | 16.39 | No |
| Example 4 | | | | | | |
| Comparative | 58.38 | 51.88 | 47.87 | 55.87 | 21.11 | No |
| Example 5 | | | | | | |
| Comparative | 72.13 | 64.58 | 60.08 | 73.19 | 14.98 | No |
| Example 6 | | | | | | |
| Comparative | 68.22 | 59.776 | 50.777 | 61.89 | 13.87 | No |
| Example 7 | | | | | | |
| Comparative | 72.16 | 68.98 | 61.09 | 73.39 | 12.98 | No |
| Example 8 | | | | | | |
| Comparative | 71.87 | 68.03 | 61.67 | 66.89 | 13.92 | No |
| Example 9 | | | | | | |

The implementations of the present disclosure are described above. However, the present disclosure is not limited to the foregoing implementations. Any modifications, equivalent replacements, improvements, and the like within the spirit and principle of the present disclosure shall fall within the scope of protection of the present disclosure.

What is claimed is:

1. A battery, comprising a positive electrode plate, a negative electrode plate, a separator, and an electrolyte solution, wherein the electrolyte solution comprises a lithium salt, an organic solvent, a first additive, and a second additive, the first additive is selected from a cyclic silane compound containing an unsaturated bond, and the second additive is selected from at least one of fluorinated cyclic carbonate compounds;
the negative electrode plate comprises a negative electrode current collector and a negative electrode active material layer coated on a surface of either or both sides of the negative electrode current collector, and the negative electrode active material layer comprises a negative electrode active material, a negative conductive agent, and a negative binder; and
the battery satisfies following relational expression: 115≤(a+1/5b)/(t×p)≤700;
wherein a is a mass percentage of the first additive in a total mass of the electrolyte solution in wt %, b is a mass percentage of the second additive in the total mass of the electrolyte solution in wt %, t is a mass of a single-side negative electrode active material layer per unit area in g/cm², and p is a specific surface area of the negative electrode active material in m²/g.

2. The battery according to claim 1, wherein the cyclic silane compound containing an unsaturated bond has a structural formula shown in Formula I: 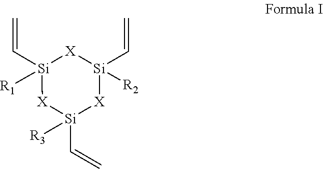
wherein in Formula I, R₁, R₂, and R₃ are the same or different and are independently selected from hydrogen, halogen, substituted or unsubstituted alkyl, substituted or unsubstituted alkenyl, substituted or unsubstituted cycloalkyl, or substituted or unsubstituted aryl; and when “substituted” is used, a substituent is halogen or alkyl; and X is selected from —CH₂—, —O—, —S—, NH, PH, or BH.

3. The battery according to claim 2, wherein R₁, R₂, and R₃ are the same or different and are independently selected from hydrogen, halogen, substituted or unsubstituted C₁₋₂₀ alkyl, substituted or unsubstituted C₂₋₂₀ alkenyl, substituted or unsubstituted 3-20 membered cycloalkyl, or substituted or unsubstituted C₆₋₂₀ aryl; and when “substituted” is used, the substituent is halogen or C₁₋₂₀ alkyl.

4. The battery according to claim 3, wherein R₁, R₂, and R₃ are the same or different and are independently selected from hydrogen, halogen, substituted or unsubstituted C₁₋₁₂ alkyl, substituted or unsubstituted C₂₋₁₂ alkenyl, substituted or unsubstituted 3-12 membered cycloalkyl, or substituted or unsubstituted C₆₋₁₂ aryl; and when “substituted” is used, the substituent is halogen or C₁₋₁₂ alkyl.

5. The battery according to claim 3, wherein R₁, R₂, and R₃ are the same or different and are independently selected from hydrogen, halogen, substituted or unsubstituted C₁₋₆ alkyl, substituted or unsubstituted C₂₋₆ alkenyl, substituted or unsubstituted 3-6 membered cycloalkyl, or substituted or unsubstituted C₆₋₁₀ aryl; and when “substituted” is used, the substituent is halogen or C₁₋₆ alkyl.

6. The battery according to claim 3, wherein R₁, R₂, and R₃ are the same or different and are independently selected from hydrogen, halogen, substituted or unsubstituted C₁₋₃ alkyl, substituted or unsubstituted C₂₋₃ alkenyl, substituted or unsubstituted 3-6 membered cycloalkyl, or substituted or unsubstituted C₆₋₈ aryl; and when “substituted” is used, the substituent is halogen or C₁₋₃ alkyl.

7. The battery according to claim 1, wherein the first additive is selected from at least one of following compounds shown in Formula I-1 to Formula I-15:

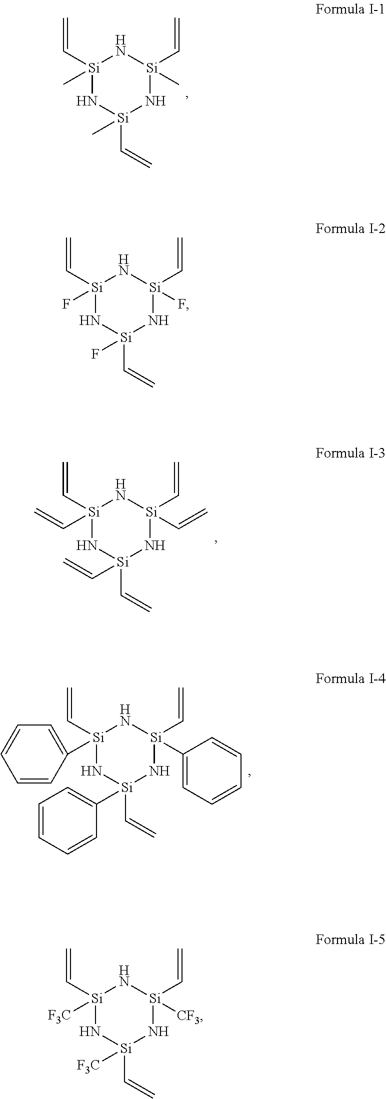 [SMILES: C=C[Si]1(C)N[Si](C)(C=C)N[Si](C)(C=C)N1 ; C=C[Si]1(F)N[Si](F)(C=C)N[Si](F)(C=C)N1 ; C=C[Si]1(C=C)N[Si](C=C)(C=C)N[Si](C=C)(C=C)N1 ; C=C[Si]1(c2ccccc2)N[Si](C=C)(c2ccccc2)N[Si](C=C)(c2ccccc2)N1 ; C=C[Si]1(C(F)(F)F)N[Si](C=C)(C(F)(F)F)N[Si](C=C)(C(F)(F)F)N1]

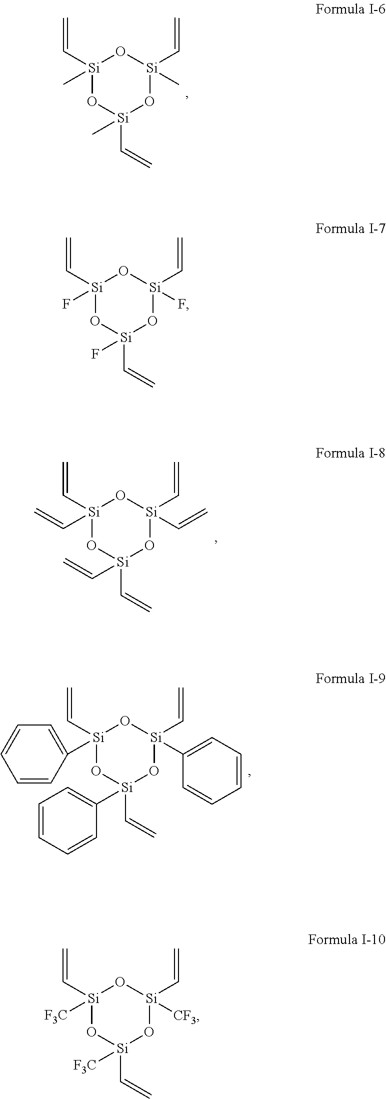 [SMILES: C=C[Si]1(C)O[Si](C)(C=C)O[Si](C)(C=C)O1 ; C=C[Si]1(F)O[Si](F)(C=C)O[Si](F)(C=C)O1 ; C=C[Si]1(C=C)O[Si](C=C)(C=C)O[Si](C=C)(C=C)O1 ; C=C[Si]1(c2ccccc2)O[Si](C=C)(c2ccccc2)O[Si](C=C)(c2ccccc2)O1 ; C=C[Si]1(C(F)(F)F)O[Si](C=C)(C(F)(F)F)O[Si](C=C)(C(F)(F)F)O1]

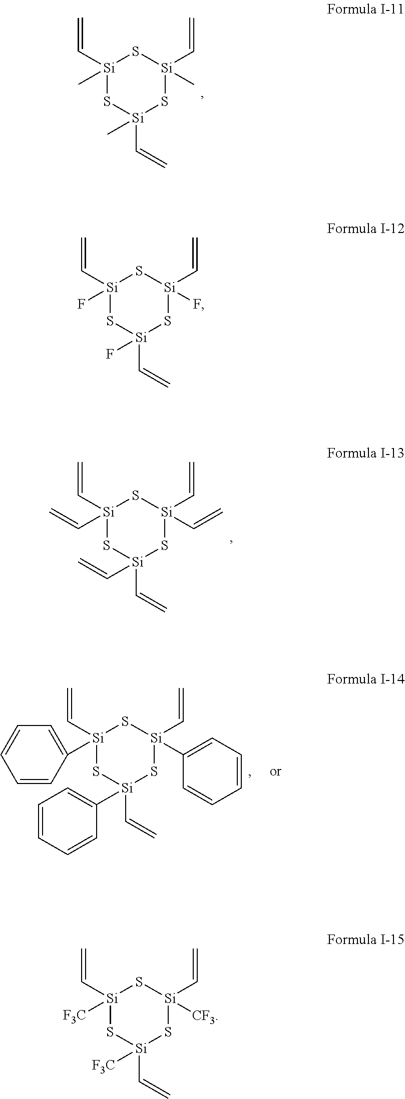 [SMILES: C=C[Si]1(C)S[Si](C)(C=C)S[Si](C)(C=C)S1 ; C=C[Si]1(F)S[Si](F)(C=C)S[Si](F)(C=C)S1 ; C=C[Si]1(C=C)S[Si](C=C)(C=C)S[Si](C=C)(C=C)S1 ; C=C[Si]1(c2ccccc2)S[Si](C=C)(c2ccccc2)S[Si](C=C)(c2ccccc2)S1 ; C=C[Si]1(C(F)(F)F)S[Si](C=C)(C(F)(F)F)S[Si](C=C)(C(F)(F)F)S1]

8. The battery according to claim 1, wherein the fluorinated cyclic carbonate compound has at least one of the structural formulas shown in Formula II: 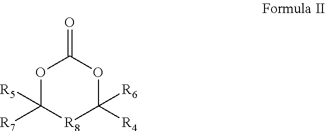
wherein in Formula II, R₄, R₅, R₆, and R₇ are the same or different and are independently selected from hydrogen, fluorine, alkyl, or fluorine-substituted alkyl, and at least one group of R₄, R₅, R₆, or R₇ is selected from fluorine or fluorine-substituted alkyl; and R₈ is absent, —CH2- or fluorine substitution.

9. The battery according to claim 8, wherein R₄, R₅, R₆, and R₇ are the same or different and are independently selected from hydrogen, fluorine, C₁₋₁₂ alkyl, or fluorine-substituted C₁₋₁₂ alkyl, and at least one group of R₄, R₅, R₆, or R₇ is selected from fluorine or fluorine-substituted C₁₋₁₂ alkyl.

10. The battery according to claim 9, wherein R₄, R₅, R₆, and R₇ are the same or different and are independently selected from hydrogen, fluorine, C₁₋₆ alkyl, or fluorine-substituted C₁₋₆ alkyl, and at least one group of R₄, R₅, R₆, or R₇ is selected from fluorine or fluorine-substituted C₁₋₆.

11. The battery according to claim 9, wherein R₄, R₅, R₆, and R₇ are the same or different and are independently selected from hydrogen, fluorine, C₁₋₃ alkyl, or fluorine-substituted C₁₋₃ alkyl, and at least one group of R₄, R₅, R₆, or R₇ is selected from fluorine or fluorine-substituted C₁₋₃ alkyl.

12. The battery according to claim 1, wherein the second additive is selected from at least one of compounds shown in Formula II-1 to Formula II-9:

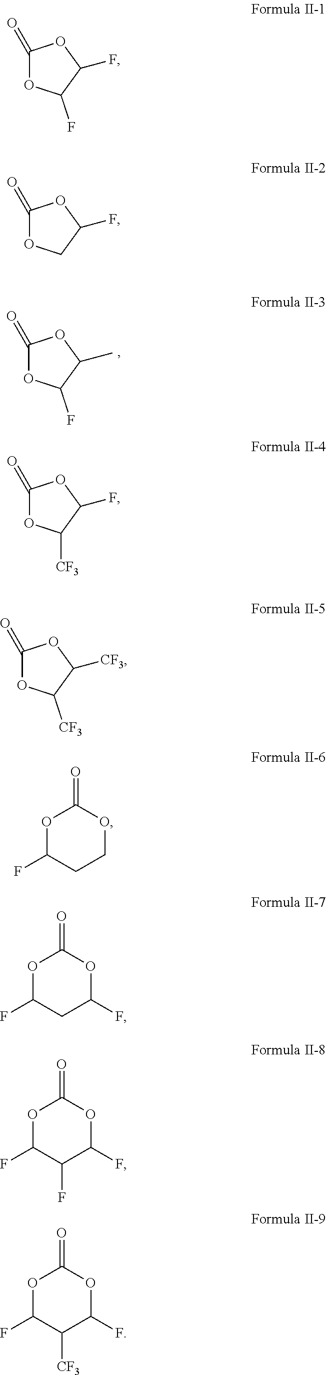

13. The battery according to claim 1, wherein 0.05 wt %≤a wt %≤5 wt %; and/or 3.5 wt %≤b wt %≤15 wt %; and/or 0.0045 g/cm²≤t g/cm²≤0.028 g/cm²; and/or 0.55 m²/g≤p m²/g≤2.35 m²/g.

14. The battery according to claim 1, wherein 130≤(a+1/5×b)/(t×p)≤200.

15. The battery according to claim 1, wherein the lithium salt is selected from one or more of lithium hexafluorophosphate, lithium difluorophosphate, lithium difluoro (oxalato) borate, lithium bis((trifluoromethanesulfonyl)imide, lithium difluorobis(oxalato)phosphate, lithium tetrafluoroborate, lithium bis(oxalate) borate, lithium hexafluoroantimonate, lithium hexafluoroarsenate, lithium bis(pentafluoroethylsulfonyl)imine, tri (trifluoromethyl sulfonyl)methyllithium, or lithium bis(trifluoromethyl sulfonyl)imine; and/or
the organic solvent is selected from carbonate and/or carboxylate, and the carbonate is selected from one or more of following fluorinated or unsubstituted solvents: ethylene carbonate, propylene carbonate, dimethyl carbonate, diethyl carbonate, or ethyl methyl carbonate; and the carboxylate is selected from one or more of following fluorinated or unsubstituted solvents: propyl acetate, n-butyl acetate, isobutyl acetate, n-amyl acetate, isoamyl acetate, propyl propionate, ethyl propionate, methyl butyrate, or ethyl n-butyrate.

16. The battery according to claim 1, wherein a mass of the lithium salt accounts for 10 wt % to 15 wt % of a total mass of the electrolyte solution; and/or
a mass of the organic solvent accounts for 65 wt % to 80 wt % of a total mass of the electrolyte solution.

17. The battery according to claim 1, wherein the negative electrode active material is at least one of a silicon-based negative electrode material or a carbon-based negative electrode material.

18. The battery according to claim 17, wherein the carbon-based negative electrode material is selected from at least one of artificial graphite, natural graphite, mesocarbon microbeads, hard carbon, or soft carbon; and/or the silicon-based negative electrode material is selected from at least one of a silicon-carbon negative electrode material or a silicon-oxygen negative electrode material;
and/or the negative electrode active material is a silicon-carbon and graphite material, or a silicon-oxygen and graphite material.

19. The battery according to claim 1, wherein the negative conductive agent is selected from at least one of conductive carbon black, acetylene black, Ketjen black, conductive graphite, conductive carbon fiber, carbon nanotubes, metal powder, or carbon fiber; and/or
the negative binder is selected from at least one of sodium carboxymethyl cellulose, styrene-butadiene latex, polytetrafluoroethylene, polyethylene oxide, or polyvinylidene fluoride.

20. The battery according to claim 1, wherein mass percentages of components in the negative electrode active material layer are as follows: 80 wt % to 99.8 wt % for the negative electrode active material, 0.1 wt % to 10 wt % for the negative conductive agent, and 0.1 wt % to 10 wt % for the negative binder.
